(19) United States
(12) Patent Application Publication
(10) Pub. No.: US 2014/0159699 A1
(43) Pub. Date: Jun. 12, 2014

(54) BANDGAP REFERENCE CIRCUIT

(71) Applicant: SONY CORPORATION, Tokyo (JP)

(72) Inventors: Taiki Iguchi, Kanagawa (JP); Sachio Akebono, Kanagawa (JP); Daisuke Hirono, Kanagawa (JP); Kiyoshi Makigawa, Kanagawa (JP); Moonjae Jeong, Kanagawa (JP)

(73) Assignee: SONY CORPORATION, Tokyo (JP)

(21) Appl. No.: 14/078,652

(22) Filed: Nov. 13, 2013

(30) Foreign Application Priority Data
Dec. 11, 2012 (JP) 2012-270104

(51) Int. Cl. H02M 3/10

(52) U.S. Cl. CPC H02M 3/10
USPC 323/313

(57) ABSTRACT

A bandgap reference circuit includes: a first PMOSFET connected to a power supply node; a first resistor connected to a drain of the first PMOSFET; a first diode connected to the first resistor and a ground node; a second PMOSFET connected to the power supply node; a second diode connected to a drain of the second PMOSFET and the ground node; a second resistor connected between the first PMOSFET and ground node; a third resistor connected between the second PMOSFET and ground node; a third PMOSFET connected to the power supply node and an output node of a reference voltage; a fourth resistor connected between the third PMOSFET and ground node; and an operational amplifier having a non-inverting input terminal connected to the first PMOSFET and an inverting input terminal connected to the second PMOSFET, an output voltage being applied to each gate of the first to third PMOSFETs.

### CROSS REFERENCE TO RELATED APPLICATIONS

This application claims the benefit of Japanese Priority Patent Application JP 2012-270104 filed Dec. 11, 2012, the entire contents of which are incorporated herein by reference.

### BACKGROUND

The present disclosure relates to a bandgap reference circuit.

Nowadays, along with miniaturizations and high integrations of semiconductor integrated circuits, circuits are requested to be operated at a low voltage, and thus integrated circuit manufacturers including the applicant have responded to the such a request. The low-voltage drive is of course also requested for a bandgap reference circuit that generates a reference voltage.

It should be noted that Japanese Patent Application Laid-open No. Hei 11-45125 (hereinafter, referred to as Patent Document 1) is a related art document that discloses a technique that is considered to be close to the present disclosure. Patent Document 1 discloses a technique for enabling an operation to be made at 1.25 V or less by setting a voltage that is output from a reference voltage generation circuit and is less dependent on a temperature and power supply voltage to an arbitrary value within a power supply voltage.

### SUMMARY

FIG. 8 is a circuit diagram of a bandgap reference circuit 801 of the related art disclosed in Patent Document 1.

A source of a first PMOSFET 102 as a P-channel MOSFET (hereinafter, abbreviated to “PMOSFET”, and N-channel MOSFET will similarly be abbreviated to “NMOSFET”) is connected to a power supply node, and a drain thereof is connected to a first resistor R103. The other end of the first resistor R103 is connected to an anode of a first diode 104. A cathode of the first diode 104 is connected to a ground node. A second resistor R105 is connected between the drain of the first PMOSFET 102 and the ground node while being connected in parallel with the first resistor R103 and the first diode 104 connected in series.

A source of a second PMOSFET 106 is connected to the power supply node, and a drain thereof is connected to an anode of a second diode 107. A cathode of the second diode 107 is connected to the ground node. A third resistor R108 is connected between the drain of the second PMOSFET 106 and the ground node while being connected in parallel with the second diode 107.

Here, resistance values of the second resistor R105 and the third resistor R108 are the same.

A source of a third PMOSFET 109 is connected to the power supply node, and a drain thereof is connected to one end of a fourth resistor R110 and also to a reference voltage output terminal Vout. The other end of the fourth resistor R110 is connected to the ground node.

A non-inverting input terminal of an operational amplifier 111 is connected to the drain of the first PMOSFET 102.

An inverting input terminal of the operational amplifier 111 is connected to the drain of the second PMOSFET 106.

An output terminal of the operational amplifier 111 is connected to gates of the first PMOSFET 102, the second PMOSFET 106, and the third PMOSFET 109, and a gate voltage is commonly controlled by the operational amplifier 111. In other words, the three PMOSFETs constitute a current mirror circuit.

As can be understood from FIG. 8, the first diode 104 is formed by connecting a plurality of diodes in parallel unlike the second diode 107. Since the bandgap reference circuit 801 is constituted of an integrated circuit, the diodes forming the first diode 104 and the second diode 107 are formed by the same production process (same electrical characteristics).

The diode includes elements of an ideal diode and a resistor. Therefore, since combined resistance values differ for the first diode 104 and the second diode 107, current densities differ.

A potential difference caused by the difference in the current densities of the first diode 104 and the second diode 107 is converted into a current I2a having positive temperature characteristics by the first resistor R103.

On the other hand, both end voltages of the second diode 107 are converted into a current I1a having negative temperature characteristics by the third resistor R108.

The non-inverting input terminal of the operational amplifier 111 is set as a voltage point VA, and the inverting input terminal thereof is set as a voltage point VB.

Since the operational amplifier 111 equivalently controls the first PMOSFET 102 connected to the voltage point VA and the second PMOSFET 106 connected to the voltage point VB, potential differences of the second resistor R105 and the third resistor R108 become the same. In addition, since the resistance values of the second resistor R105 and the third resistor R108 are the same, a current I2b flowing through the second resistor R105 and a current I1b flowing through the third resistor R108 also become the same.

The third PMOSFET 109 constituting a constant current source outputs a sum current of the currents I2a and I2b by the current mirror circuit. Since the sum current has opposite temperature characteristics, the voltage caused in the fourth resistor R110 becomes a reference voltage having no temperature characteristics.

By using the technique disclosed in Patent Document 1, the bandgap reference circuit 801 with which a reference voltage having no temperature characteristics can be obtained can be realized. However, the circuit disclosed in Patent Document 1 has a quasi-stabilization point as will be described later. Therefore, a startup circuit for eliminating an erroneous stabilization at the quasi-stabilization point becomes necessary.

An example of the startup circuit is shown in FIG. 9.

FIG. 9 is a circuit diagram of a bandgap reference circuit 901 of the related art including the startup circuit. The bandgap reference circuit 901 shown in FIG. 9 has a structure in which a startup circuit 900 is added to the bandgap reference circuit 801 shown in FIG. 8.

The same current as the third PMOSFET 109 is caused to flow through a PMOSFET 902 of the startup circuit 900 to thus cause a voltage in a resistor R903. An inter-terminal voltage of the resistor R903 is input to a gate of a PMOSFET 904 and a gate of an NMOSFET 905 constituting an inverter. A drain of the PMOSFET 904 and a drain of the NMOSFET 905 are connected to a gate of an NMOSFET 906.

Since the inter-terminal voltage of the resistor R903 is almost the same as the ground potential at a time the bandgap reference circuit 901 is activated, the inverter becomes a high potential, and the NMOSFET 906 is put to an ON state. After that, the inverter shifts to a low potential as the inter-terminal voltage of the resistor R903 increases, and the NMOSFET 906 is put to an OFF state. In other words, the circuit is stabilized by dropping the voltage controlling the power supply source to the ground potential during an unstable state at the time the circuit is activated.

However, provision of the startup circuit 900 leads to an increase in the number of components to thus result in an enlargement of a circuit scale in the integrated circuit. Moreover, depending on a production process of the integrated circuit, it may be difficult to incorporate the startup circuit 900.

In view of the circumstances as described above, there is a need for a bandgap reference circuit that does not have a quasi-stabilization point and outputs a stable voltage.

According to an embodiment of the present disclosure, there is provided a bandgap reference circuit including: a first PMOSFET having a source connected to a power supply node; a first resistor having one end connected to a drain of the first PMOSFET; a first diode connected to the other end of the first resistor and a ground node; a second PMOSFET having a source connected to the power supply node; a second diode connected to a drain of the second PMOSFET and the ground node; a second resistor connected between the drain of the first PMOSFET and the ground node; and a third resistor connected between the drain of the second PMOSFET and the ground node.

The bandgap reference circuit also includes: a third PMOSFET having a source connected to the power supply node and a drain connected to an output node of a reference voltage; a fourth resistor connected between the drain of the third PMOSFET and the ground node; and an operational amplifier having a non-inverting input terminal connected to the drain of the first PMOSFET and an inverting input terminal connected to the drain of the second PMOSFET, to which a voltage higher than a voltage supplied to the non-inverting input terminal may be supplied, an output voltage of the operational amplifier being applied to each gate of the first PMOSFET, the second PMOSFET, and the third PMOSFET.

According to the embodiment of the present disclosure, a bandgap reference circuit that does not have a quasi-stabilization point and outputs a stable voltage can be provided without providing a startup circuit.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a circuit diagram of a bandgap reference experiment circuit in which an experiment for explaining a principle of the present disclosure has been performed;

FIG. 2 is a graph showing a result of the experiment for explaining the principle of the present disclosure;

FIG. 3 is a circuit diagram of a bandgap reference circuit according to a first embodiment of the present disclosure;

FIG. 4 is a graph showing a result of an experiment performed on the bandgap reference circuit according to the first embodiment of the present disclosure;

FIG. 5 is a circuit diagram of a bandgap reference circuit according to a second embodiment of the present disclosure;

FIG. 6 is a circuit diagram of a bandgap reference circuit according to a third embodiment of the present disclosure;

FIG. 7 is a circuit diagram of a bandgap reference circuit according to a fourth embodiment of the present disclosure;

FIG. 8 is a circuit diagram of a bandgap reference circuit of the related art; and

FIG. 9 is a circuit diagram of a bandgap reference circuit of the related art including a startup circuit.

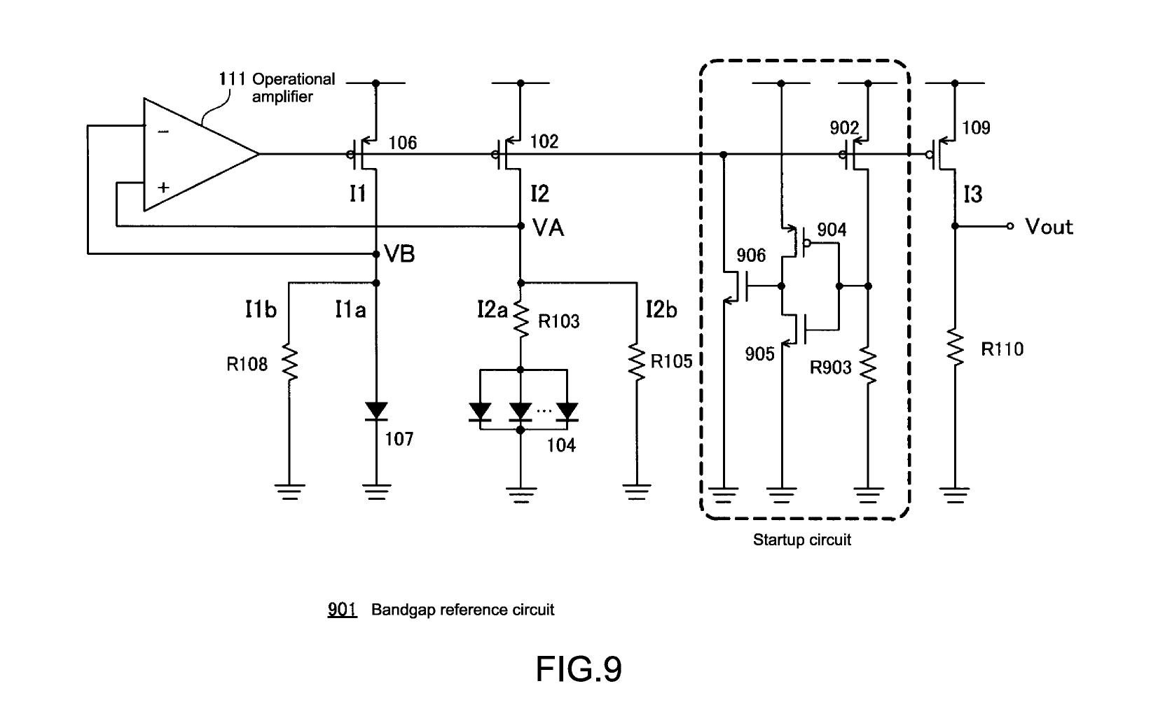

### DETAILED DESCRIPTION OF EMBODIMENTS

Hereinafter, embodiments of the present disclosure will be described with reference to the drawings.

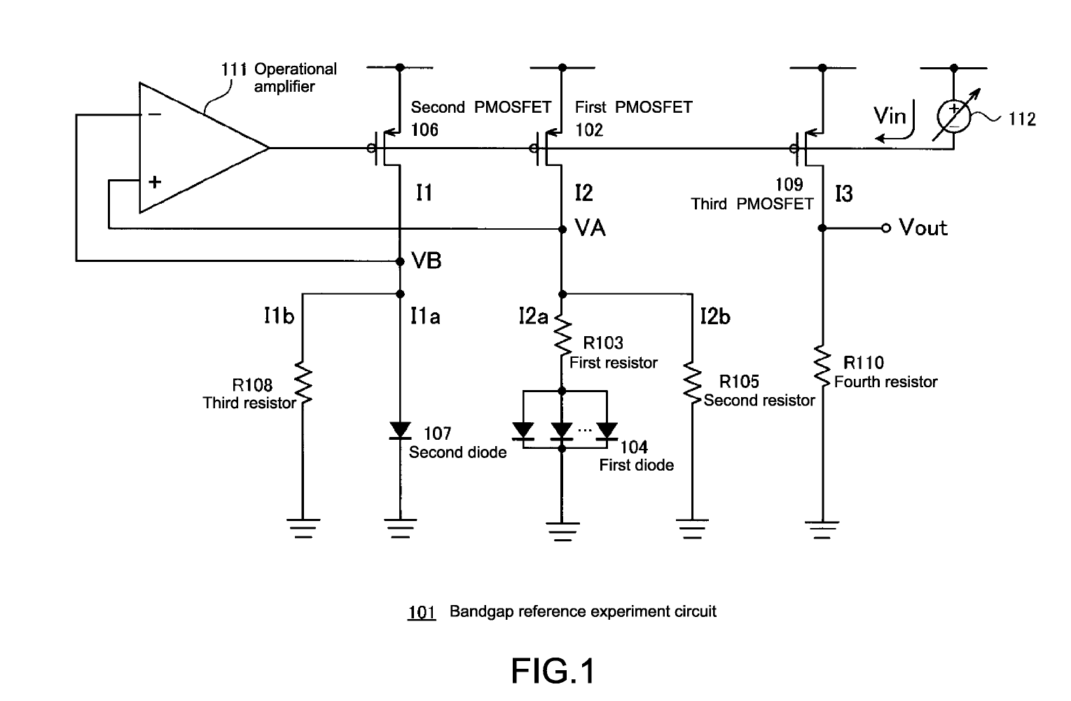

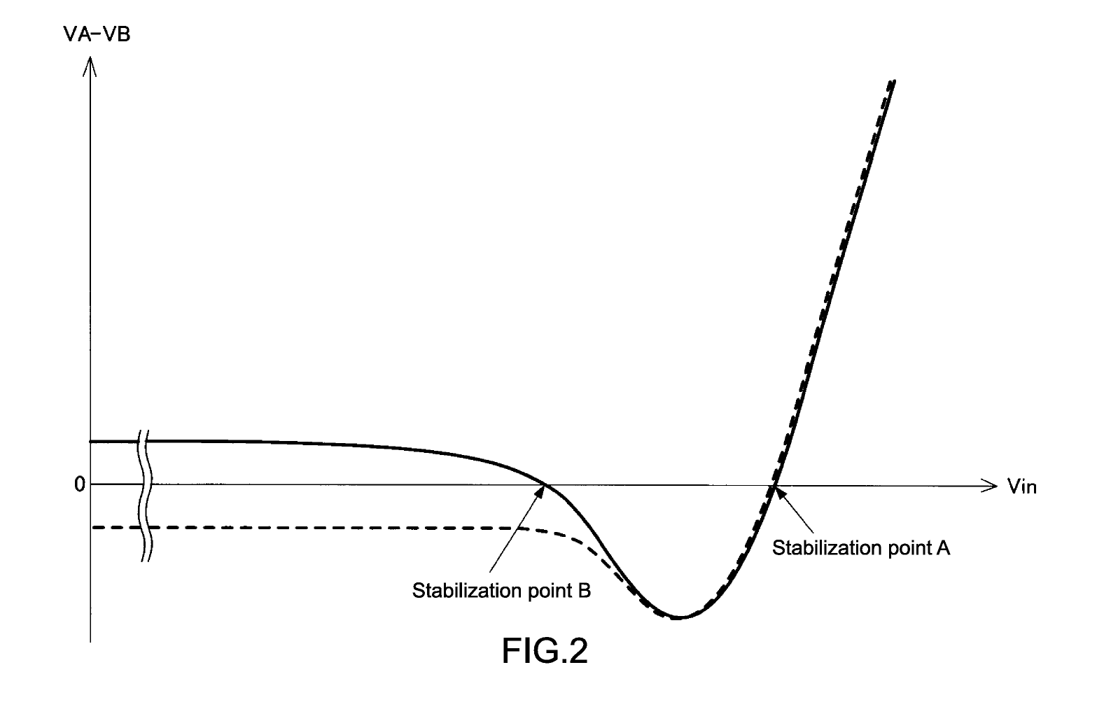

(Principle of present disclosure) (FIGS. 1 and 2: operational characteristics of bandgap reference circuit)

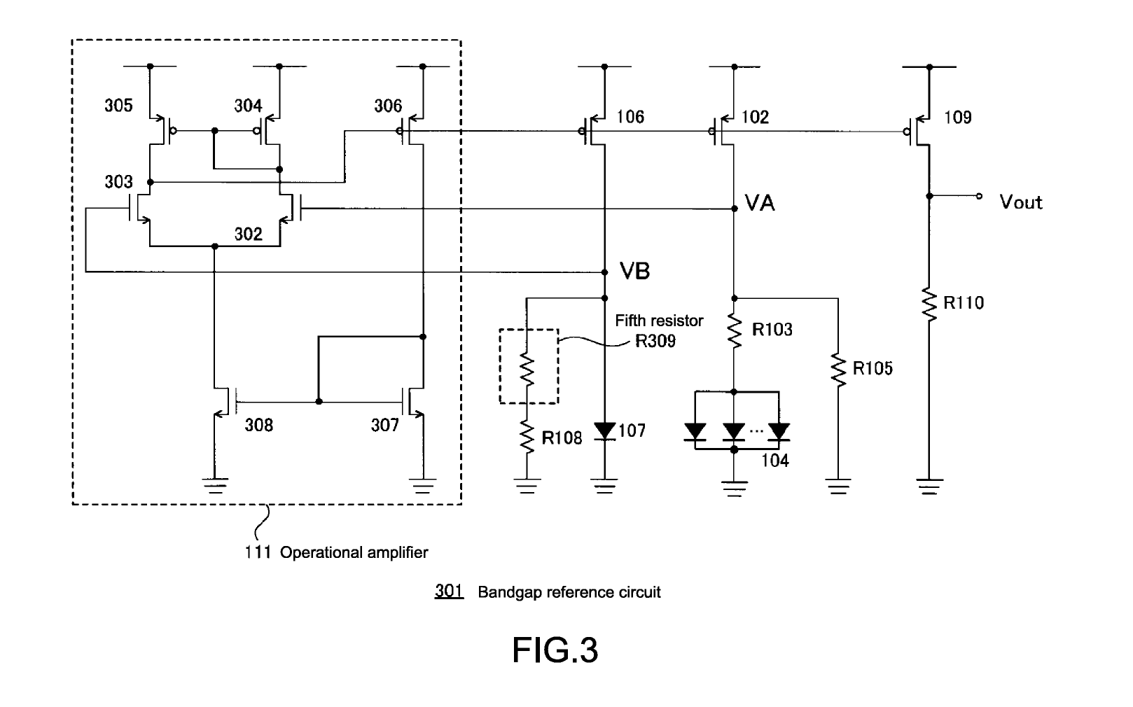

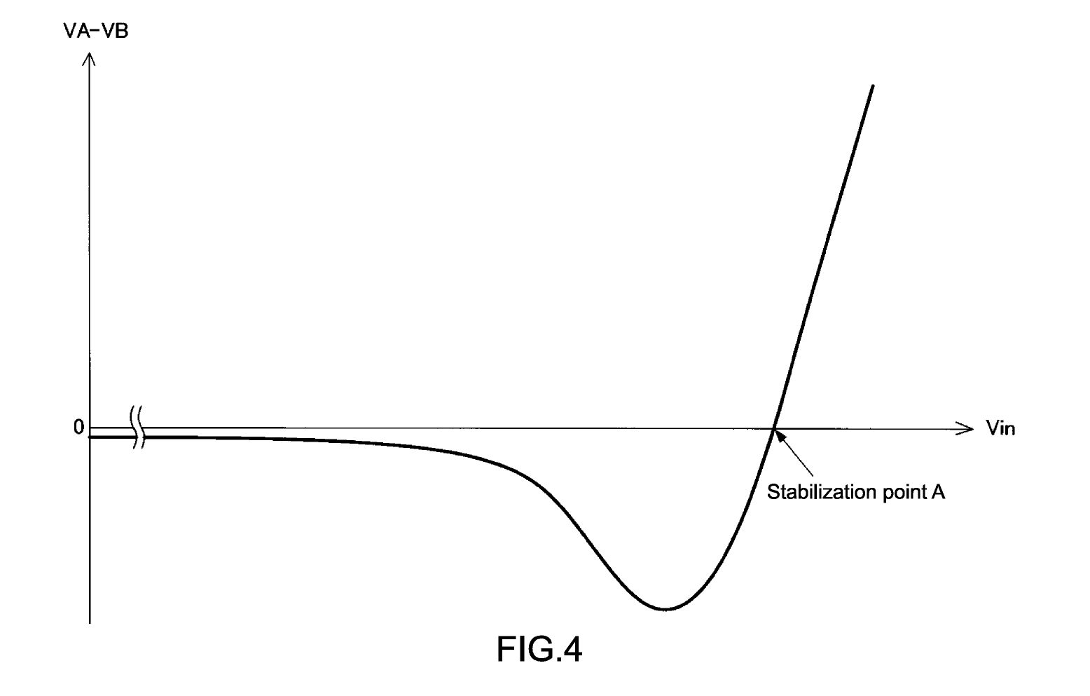

(First embodiment) (FIGS. 3 and 4: bandgap reference circuit 301 to which unbalanced resistor is applied)

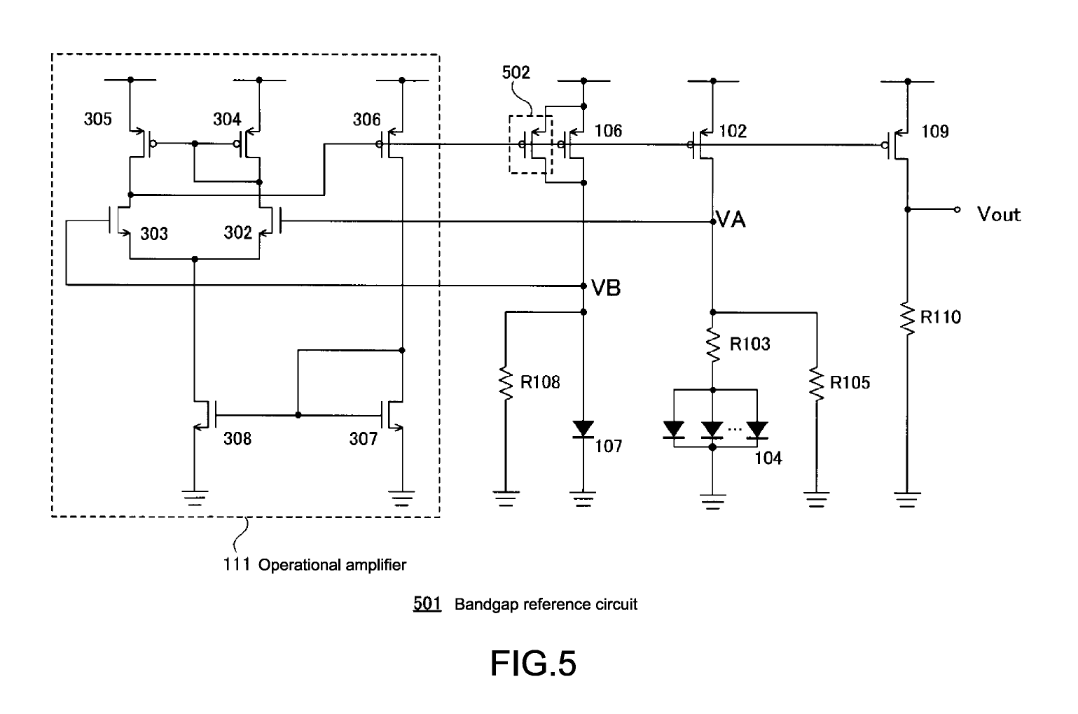

(Second embodiment) (FIG. 5: bandgap reference circuit 501 to which unbalanced power supply source is applied)

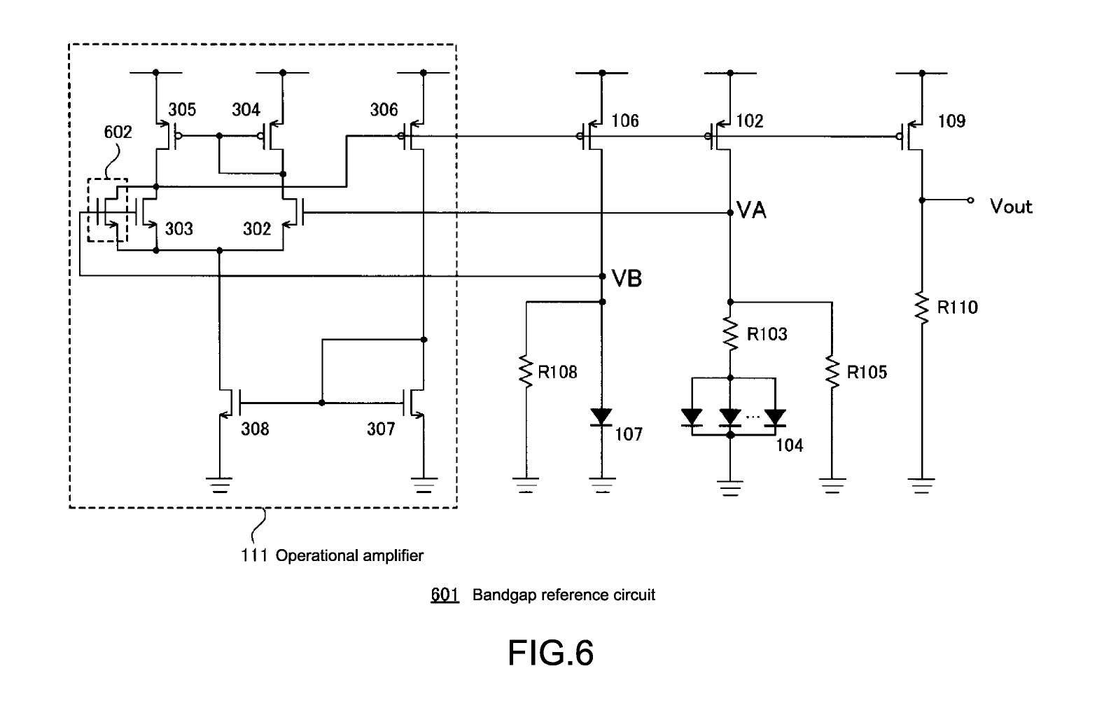

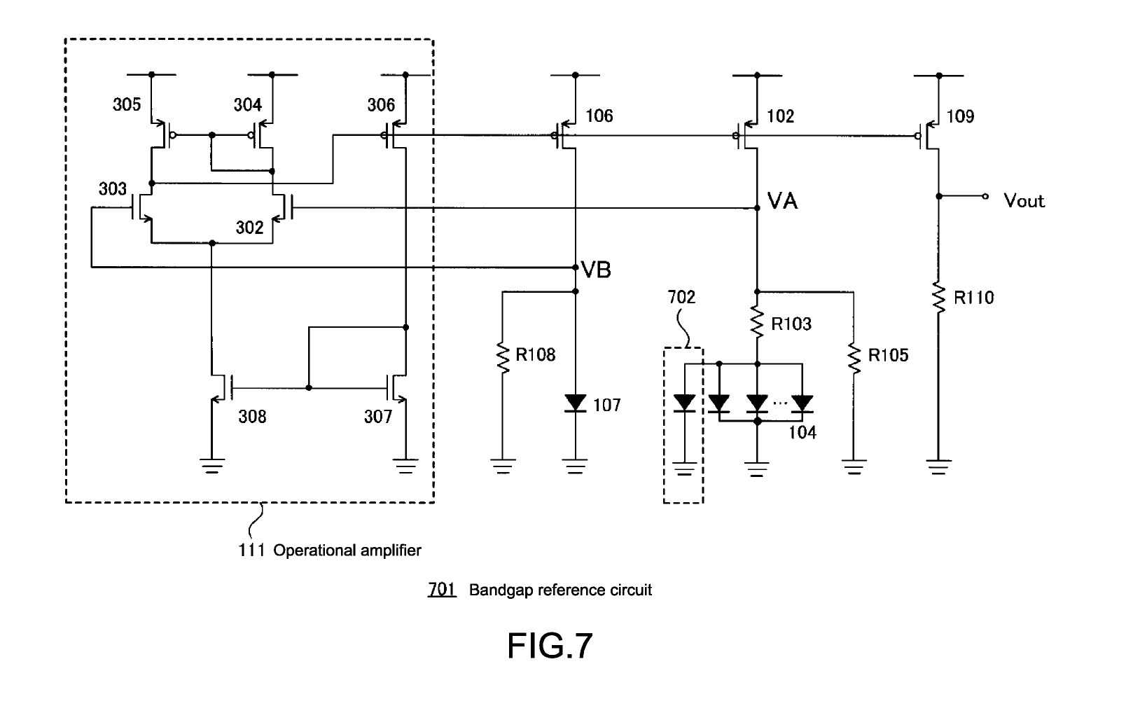

(Third embodiment) (FIG. 6: bandgap reference circuit 601 to which unbalanced differential input stage of operational amplifier is applied) (Fourth embodiment) (FIG. 7: bandgap reference circuit 701 to which unbalanced diode is applied)

### PRINCIPLE OF PRESENT DISCLOSURE

Before explaining the technique of the present disclosure, an operation of a bandgap reference circuit will be described to help understand the technique the present disclosure.

FIG. 1 is a circuit diagram of a bandgap reference experiment circuit 101 in which an experiment for explaining a principle of the present disclosure has been performed.

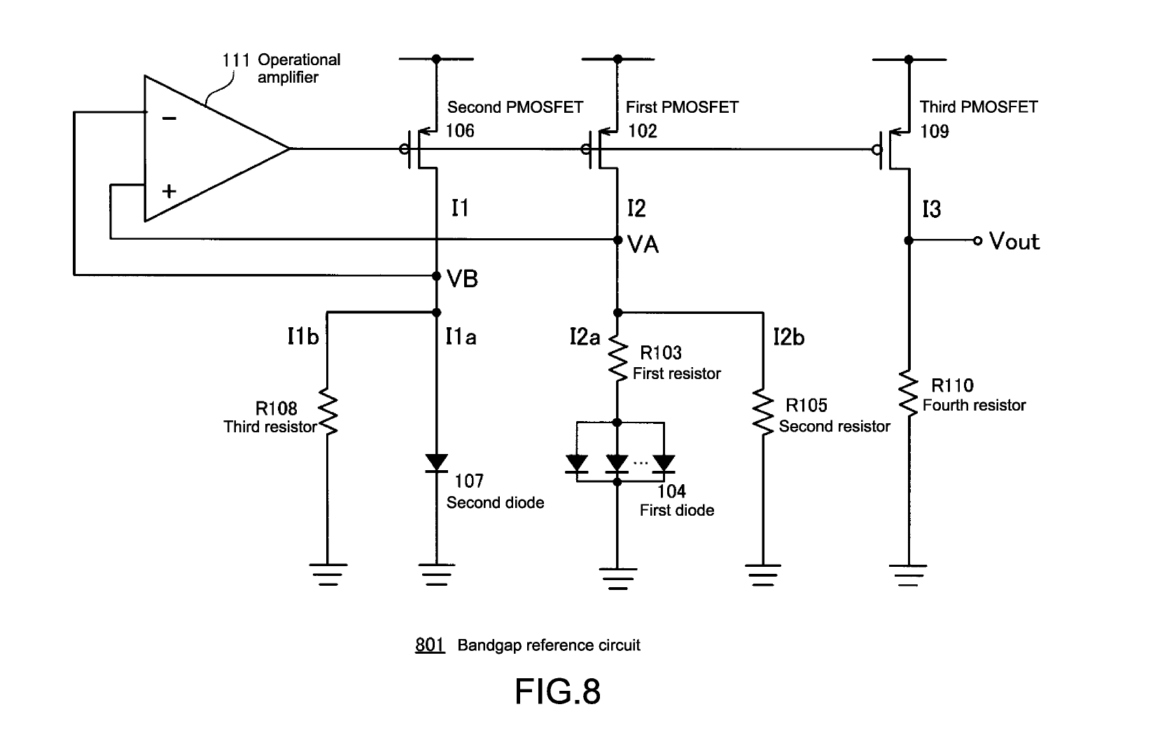

The bandgap reference experiment circuit 101 shown in FIG. 1 has a structure in which a variable voltage source 112 is connected to the first PMOSFET 102, the second PMOSFET 106, and the third PMOSFET 109 of the bandgap reference circuit 801 shown in FIG. 8.

The source of the first PMOSFET 102 is connected to the power supply node, and the drain thereof is connected to the first resistor R103. The other end of the first resistor R103 is connected to the anode of the first diode 104. The cathode of the first diode 104 is connected to the ground node. The second resistor R105 is connected between the drain of the first PMOSFET 102 and the ground node while being connected in parallel to the first resistor R103 and the first diode 104 connected in series.

The source of the second PMOSFET 106 is connected to the power supply node, and the drain thereof is connected to the anode of the second diode 107. The cathode of the second diode 107 is connected to the ground node. The third resistor R108 is connected between the drain of the second PMOSFET 106 and the ground node while being connected in parallel to the second diode 107.

Here, resistance values of the second resistor R105 and the third resistor R108 are the same.

The source of the third PMOSFET 109 is connected to the power supply node, and the drain thereof is connected to one end of the fourth resistor R110 and the reference voltage output terminal Vout. The other end of the fourth resistor R110 is connected to the ground node.

The non-inverting input terminal of the operational amplifier 111 is connected to the drain of the first PMOSFET 102.

The inverting input terminal of the operational amplifier 111 is connected to the drain of the second PMOSFET 106.

The output terminal of the operational amplifier 111 is connected to the gates of the first PMOSFET 102, the second PMOSFET 106, and the third PMOSFET 109, and the gate voltages are commonly controlled by the operational amplifier 111. In other words, the three PMOSFETs constitute a current mirror circuit.

By controlling the variable voltage source 112 of the bandgap reference experiment circuit 101 and forcibly changing the gate voltages of the first PMOSFET 102, the second PMOSFET 106, and the third PMOSFET 109 from 0 V to a predetermined voltage, a difference between the voltage point VA connected to the non-inverting input terminal of the operational amplifier 111 and the voltage point VB connected to the inverting input terminal of the operational amplifier 111 (VA-VB) is observed.

FIG. 2 is a graph showing a result of the experiment for explaining the principle of the present disclosure. In the graph of FIG. 2, the abscissa axis represents the voltage of the variable voltage source 112, and the ordinate axis represents VA-VB.

While VA-VB keeps a positive potential as an output voltage Vin of the variable voltage source 112 is gradually raised from 0 V, VA-VB becomes 0 V when Vin reaches a certain voltage and shifts to a negative potential after that. Then, after VA-VB reaches a peak of the negative potential, VA-VB again becomes 0 V and rapidly increases after that.

Specifically, as can be understood from FIG. 2, there are two voltages Vin as stabilization points at which VA-VB becomes 0 V in the bandgap reference circuit. Of those, the stabilization point A is an originally desired stabilization point, and the stabilization point B is an undesired quasi-stabilization point.

The cause of the fundamental problem that a quasi-stabilization point exists in a bandgap reference circuit is that a current caused by the power supply source is small, and when the first diode 104 and the second diode 107 cannot be put to an ON state, the voltage at the voltage point VA is determined based on the currents of the second resistor R105 connected in parallel to the first diode 104 and the first PMOSFET 102, and the voltage at the voltage point VB is determined based on the currents of the third resistor R108 connected in parallel to the second diode 107 and the second PMOSFET 106.

In principle, although the resistance values of the second resistor R105 and the third resistor R108 are considered to be the same, the voltages at the voltage points VA and VB cannot be uniquely determined due to a mismatch, offset, and the like in the production process of the circuit to be actually used, and thus VA-VB may take both positive and negative values. When VA-VB takes a positive voltage value, a quasi-stabilization point is caused as indicated by the solid line of FIG. 2.

When the circuit is structured such that VA-VB takes a negative voltage value, the quasi-stabilization point is eliminated as indicated by the broken line of FIG. 2. This is the principle of the present disclosure.

### First Embodiment

FIG. 3 is a circuit diagram of a bandgap reference circuit 301 according to a first embodiment of the present disclosure. In the circuit shown in FIG. 3, circuit elements that are the same as those shown in FIG. 1 will be denoted by the same symbols, and descriptions thereof will be omitted. The bandgap reference circuit 301 has a structure in which the variable voltage source 112 of the bandgap reference experiment circuit 101 shown in FIG. 1 is removed, and a fifth resistor R309 is added. It should be noted that FIG. 3 shows an example of an inner portion of the operational amplifier 111.

The drain of the first PMOSFET 102 is connected to a gate of an NMOSFET 302.

The drain of the second PMOSFET 106 is connected to a gate of an NMOSFET 303.

A source of a PMOSFET 304 is connected to the power supply node, and a drain thereof is connected to a drain of the NMOSFET 302 and also to a gate of the PMOSFET 304.

A source of a PMOSFET 305 is connected to the power supply node, and a drain thereof is connected to a drain of the NMOSFET 303 and also to a gate of a PMOSFET 306.

A source of the PMOSFET 306 is connected to the power supply node, and a drain thereof is connected to a drain of an NMOSFET 307.

Further, the PMOSFET 305 is connected not only to the gate of the PMOSFET 306 but also to the gates of the first PMOSFET 102, the second PMOSFET 106, and the third PMOSFET 109.

The source of the NMOSFET 302 and the source of the NMOSFET 303 are connected to a drain of an NMOSFET 308. A source of the NMOSFET 308 is connected to the ground node. A gate of the NMOSFET 308 is connected to the gate of the NMOSFET 307 and also to the drain of the NMOSFET 307.

The PMOSFETs 304, 305, and 306 and the NMOSFETs 302, 303, 307, and 308 constitute the operational amplifier 111.

FIG. 4 is a graph showing a result of an experiment performed on the bandgap reference circuit 301 according to the first embodiment of the present disclosure.

As described above, the bandgap reference circuit 301 shown in FIG. 3 is different from the bandgap reference experiment circuit 101 shown in FIG. 1 in that the fifth resistor R309 is connected in series with the third resistor R108. In other words, since a sum resistance of the third resistor R108 and the fifth resistor R309 is larger than the resistance value of the second resistor R105, the voltage VB becomes slightly larger than the voltage VA. Therefore, since VA-VB takes a negative voltage value, the quasi-stabilization point B shown in FIG. 2 is eliminated and only the stabilization point A remains as shown in FIG. 4.

How to set the resistance value of the fifth resistor R309 to be added for eliminating the quasi-stabilization point will be described below.

The purpose of refining the bandgap reference circuit of the present disclosure is to set the resistance value of the fifth resistor R309 such that VA-VB always takes a negative voltage value at the time the circuit is activated.

As described above, variances are caused in the circuit elements due to an offset and the like in the production process of an integrated circuit. The resistance value of the fifth resistor R309 only needs to be set such that VA-VB always takes a negative voltage value at the time the circuit is activated without being affected by the variances of the circuit elements.

At a time point the first diode 104 is not in the ON state, the elements that determine the voltage VA are the second resistor R105 and the first PMOSFET 102 as the power supply source.

Similarly, at a time point the second diode 107 is not in the ON state, the elements that determine the voltage VB are the third resistor R108 and the second PMOSFET 106 as the power supply source.

As an example, it is assumed that the second resistor R105 and the third resistor R108 are 100 kΩ), currents output from the first PMOSFET 102 and the second PMOSFET 106 are 10 μA, and each element has an error of 1%.

A sum value Msum of the variances of the resistor and power supply source is obtained as follows.

Msum=\sqrt{(1%)²+(1%)²}=\sqrt{2}%( [symbol] 1.414%) (about 1.414%) (Expression 1)

Specifically, the resistance value of the fifth resistor R309 (see FIG. 3) to be added only needs to be set to a value exceeding 1.414% of the third resistor R108. For example, when set to 2%, by adding 2% of 100 kΩ, that is, 2 kΩ, the bandgap reference circuit 301 of the present disclosure can be realized.

Generalizing the expression above, when an error of the second resistor R105 and the third resistor R108 is represented by a(%) and an error of the currents output from the first PMOSFET 102 and the second PMOSFET 106 as the power supply source is represented by b(%), the sum value Msm of the variances of the resistor and power supply source and the resistance value of the fifth resistor R309 to be added are obtained as follows.

Msum=\sqrt{(a%)²+(b%)²}

R309>R108×(1+\sqrt{(a%)²+(b%)²}) (Expression 2)

It should be noted that the expression above may change when the circuit arrangement structure (topology) of the bandgap reference circuit changes and the elements controlling the variances change.

On the contrary, when the resistance value of the fifth resistor R309 to be added is too large, an operation with largely-deviated temperature characteristics and large variances is caused, and thus an operation as the bandgap reference circuit 301 practically cannot be established. Therefore, the resistance value of the fifth resistor R309 to be added is smaller the better and is set to a value exceeding the variances of the elements. The upper limit is determined according to the specification of the bandgap reference circuit.

As described heretofore, by adding the fifth resistor R309 having an appropriate value, the bandgap reference circuit 301 that supplies a stable voltage can be realized without providing a startup circuit.

### Second Embodiment

FIG. 5 is a circuit diagram of a bandgap reference circuit 501 according to a second embodiment of the present disclosure. It should be noted that in the circuit shown in FIG. 5, circuit elements that are the same as those shown in FIG. 3 will be denoted by the same symbols, and descriptions thereof will be omitted.

The bandgap reference circuit 501 shown in FIG. 5 is different from the bandgap reference circuit 301 shown in FIG. 3 in that a PMOSFET 502 is connected in parallel to the second PMOSFET 106 constituting the power supply source. As described above, in the production process of an integrated circuit, a plurality of small MOSFETs are connected in parallel for improving an amplification factor, a gate resistance value, and the like of the MOSFETs. At this time, each element of the small MOSFETs is called finger. In the circuit shown in FIG. 5, the fingers are provided more in the second PMOSFET 106 and the PMOSFET 502 as the power supply source that outputs the voltage VB than the first PMOSFET 102 as the power supply source that outputs the voltage VA. In particular, since the addition of the PMOSFET 502 shown in FIG. 5 leads to an addition of a current mirror, a current design is relatively easy. Moreover, as another example, there is a design in which a W length of MOS is changed in a multiple manner.

The same idea as the calculation of the resistance value described above can be applied to the calculation of the number of fingers in adding a finger of the power supply source. In other words, the addition of a finger of the power supply source is also based on the same design idea as setting the resistance value of the fifth resistor R309 so that VA-VB takes a negative voltage value as described in the first embodiment.

By causing VA-VB to take a negative voltage value at the circuit activation time point by the addition of a finger of the power supply source, the bandgap reference circuit that supplies a stable voltage can be realized even without a startup circuit as in the case shown in FIG. 3.

### Third Embodiment

FIG. 6 is a circuit diagram of a bandgap reference circuit 601 according to a third embodiment of the present disclosure. It should be noted that in the circuit shown in FIG. 6, circuit elements that are the same as those shown in FIG. 3 will be denoted by the same symbols, and descriptions thereof will be omitted.

The bandgap reference circuit 601 shown in FIG. 6 is different from the bandgap reference circuit 301 shown in FIG. 3 in that a finger of the NMOSFET 302 on the inverting input terminal side (NMOSFET 602) regarding the VB input terminal of the NMOSFET constituting the input stage of the operational amplifier 111 is added.

The same idea as the calculation of a resistance value above can be applied to the calculation of the number of fingers used in adding a finger at the input stage of the operational amplifier 111. In other words, the addition of a finger at the input stage of the operational amplifier 111 is a design idea of substituting, by the operational amplifier 111, the addition of the fifth resistor R309 of the first embodiment by adding an offset voltage to the input stage of the operational amplifier 111 itself.

By setting VA-VB to be a negative voltage value at the circuit activation time point by adding a finger at the input stage of the operational amplifier, the bandgap reference circuit that supplies a stable voltage can be realized even without a startup circuit as in the case shown in FIG. 3.

### Fourth Embodiment

FIG. 7 is a circuit diagram of a bandgap reference circuit 701 according to a fourth embodiment of the present disclosure. It should be noted that in the circuit shown in FIG. 7, circuit elements that are the same as those shown in FIG. 3 will be denoted by the same symbols, and descriptions thereof will be omitted.

The bandgap reference circuit 701 shown in FIG. 7 is different from the bandgap reference circuit 301 shown in FIG. 3 in that a third diode 702 is connected in parallel to the first diode 104. The parallel connection of the diodes is based on an idea close to that of the addition of a finger of the MOSFET.

In designing a bandgap reference circuit, a ratio of the number of diodes of the first diode 104 and the second diode 107 is 8:1 in many cases. By adding the number of diodes to be connected in parallel to such a general design, a current density is additionally changed like 9:1, 10:1, or the like, and thus a quasi-stabilization point is canceled.

The first to third embodiments described with reference to FIGS. 3, 5, and 6 aim at raising the voltage VB to be higher than the voltage VA. In contrast, the fourth embodiment shown in FIG. 7 aims at dropping the voltage VA below the voltage VB.

The same idea as the calculation of a resistance value above can be applied to the calculation of the number of diodes used in connecting the diodes in parallel. In other words, the addition of the first diode 104 to be connected in parallel is a design idea of substituting, by the first diode 104, the addition of the fifth resistor R309 of the first embodiment by causing the second diode 107 to be put to the ON state more easily than the first diode 104.

By setting VA-VB to be a negative voltage value by adding the parallel connection of the diodes, the bandgap reference circuit that supplies a stable voltage can be realized even without a startup circuit as in the case shown in FIG. 3.

The present disclosure may also take the following structures.

(1) A bandgap reference circuit, including:

a first PMOSFET having a source connected to a power supply node;

a first resistor having one end connected to a drain of the first PMOSFET;

a first diode connected to the other end of the first resistor and a ground node;

a second PMOSFET having a source connected to the power supply node;

a second diode connected to a drain of the second PMOSFET and the ground node;

a second resistor connected between the drain of the first PMOSFET and the ground node;

a third resistor connected between the drain of the second PMOSFET and the ground node;

a third PMOSFET having a source connected to the power supply node and a drain connected to an output node of a reference voltage;

a fourth resistor connected between the drain of the third PMOSFET and the ground node; and

an operational amplifier having a non-inverting input terminal connected to the drain of the first PMOSFET and an inverting input terminal connected to the drain of the second PMOSFET, to which a voltage higher than a voltage supplied to the non-inverting input terminal may be supplied, an output voltage of the operational amplifier being applied to each gate of the first PMOSFET, the second PMOSFET, and the third PMOSFET.

(2) The bandgap reference circuit according to (1),

in which a value larger than a square root of a value obtained by adding a square of an error of the second PMOSFET and a square of an error of the second diode is given to the circuit element so that a second voltage output from the drain of the second PMOSFET becomes larger than a first voltage output from the drain of the first PMOSFET.

(3) The bandgap reference circuit according to (2),

in which the third resistor has a larger resistance value than the second resistor.

(4) The bandgap reference circuit according to (2),

in which the second PMOSFET has higher power supply performance than the first PMOSFET.

(5) The bandgap reference circuit according to (2),

in which the operational amplifier includes
a first NMOSFET connected to the non-inverting input terminal, and
a second NMOSFET that is connected to the inverting input terminal and has a larger amplification factor than the first NMOSFET.
   (6) The bandgap reference circuit according to (2),

in which the first diode has higher current supply performance than the second diode.

This embodiment has disclosed the bandgap reference circuit.

The bandgap reference circuit of the related art has had a problem that a voltage at a quasi-stabilization point that is lower than a desired reference voltage is output due to essential characteristics, and an addition of a startup circuit has been necessary for eliminating such a problem.

The present disclosure has focused on the essential characteristics of the bandgap reference circuit and selected a circuit element so that the voltage VB of the second power supply source connected to the inverting input terminal of the operational amplifier becomes higher than the voltage VA of the first power supply source connected to the non-inverting input terminal of the operational amplifier.

The selection of the circuit element can be performed in at least the following 4 manners.

First, the resistor connected in parallel to the diode is differentiated only by a value exceeding a square root of a sum of the variances of the circuit elements.

Second, a current output from the second power supply source is set to be more than that of the first power supply source only by a value exceeding a square root of the sum of the variances of the circuit elements.

Third, the number of fingers at the input stage of the inverting input terminal of the operational amplifier is set to be larger than the number of fingers at the input stage of the non-inverting input terminal of the operational amplifier only by a value exceeding a square root of the sum of the variances of the circuit elements.

Fourth, the number of diodes to be connected to the first power supply source is set to be larger than the number of diodes to be connected to the second power supply source only by a value exceeding a square root of the sum of the variances of the circuit elements.

By adopting such means, a bandgap reference circuit that supplies a stable voltage can be realized even without a startup circuit.

Heretofore, the embodiments of the present disclosure have been described. However, the present disclosure is not limited to the embodiments above and includes other modified examples and application examples without departing from the gist of the present disclosure.

For example, the embodiments above have been given for minutely and specifically explaining the structures of the apparatus and system to help understand the present disclosure and are not necessarily limited to that including all the structures described above. Moreover, it is possible to replace a part of a structure of a certain embodiment with a structure of another embodiment, and it is also possible to add a structure of another embodiment to a structure of a certain embodiment. In addition, regarding a part of a structure of each embodiment, an addition/deletion/replacement using other structures can be performed.

Further, a part or all of the structures, functions, processors, and the like described above may be realized by hardware by, for example, designing them in an integrated circuit. Furthermore, the structures, functions, and the like described above may be realized by software used for a processor to interpret and execute programs for realizing the functions. Information on the programs for realizing the functions, a table, a file, and the like can be stored in a volatile or nonvolatile storage such as a memory, a hard disk, and an SSD (Solid State Drive) or a recording medium such as an IC card and an optical disc.

In addition, only the control lines and information lines that are necessary for the explanation are shown, and not all the control lines and information lines regarding a product are shown. In actuality, most of the structures are mutually connected.

It should be understood by those skilled in the art that various modifications, combinations, sub-combinations and alterations may occur depending on design requirements and other factors insofar as they are within the scope of the appended claims or the equivalents thereof.

What is claimed is:

1. A bandgap reference circuit, comprising:
a first PMOSFET having a source connected to a power supply node;
a first resistor having one end connected to a drain of the first PMOSFET;
a first diode connected to the other end of the first resistor and a ground node;
a second PMOSFET having a source connected to the power supply node;
a second diode connected to a drain of the second PMOSFET and the ground node;
a second resistor connected between the drain of the first PMOSFET and the ground node;
a third resistor connected between the drain of the second PMOSFET and the ground node;
a third PMOSFET having a source connected to the power supply node and a drain connected to an output node of a reference voltage;
a fourth resistor connected between the drain of the third PMOSFET and the ground node; and
an operational amplifier having a non-inverting input terminal connected to the drain of the first PMOSFET and an inverting input terminal connected to the drain of the second PMOSFET, to which a voltage higher than a voltage supplied to the non-inverting input terminal may be supplied, an output voltage of the operational amplifier being applied to each gate of the first PMOSFET, the second PMOSFET, and the third PMOSFET.

2. The bandgap reference circuit according to claim 1,
wherein a value larger than a square root of a value obtained by adding a square of an error of the second PMOSFET and a square of an error of the second diode is given to the circuit element so that a second voltage output from the drain of the second PMOSFET becomes larger than a first voltage output from the drain of the first PMOSFET.

3. The bandgap reference circuit according to claim 2,
wherein the third resistor has a larger resistance value than the second resistor.

4. The bandgap reference circuit according to claim 2,
wherein the second PMOSFET has higher power supply performance than the first PMOSFET.

5. The bandgap reference circuit according to claim 2,
wherein the operational amplifier includes
a first NMOSFET connected to the non-inverting input terminal, and
a second NMOSFET that is connected to the inverting input terminal and has a larger amplification factor than the first NMOSFET.
